(19) United States
(12) Patent Application Publication
(10) Pub. No.: US 2017/0128949 A1
(43) Pub. Date: May 11, 2017

(54) GRINDSTONE AND GRINDING DEVICE

(71) Applicant: TAKAI TOFU & SOYMILK EQUIPMENT CO., Ishikawa (JP)

(72) Inventors: Toichiro TAKAI, Nonoichi-shi, Ishikawa (JP); Masahiro YOSHIDA, Nonoichi-shi, Ishikawa (JP); Makoto JIOU, Nonoichi-shi, Ishikawa (JP); Toru AWAZU, Nonoichi-shi, Ishikawa (JP)

(73) Assignee: TAKAI TOFU & SOYMILK EQUIPMENT CO., Ishikawa (JP)

(21) Appl. No.: 15/322,958

(22) PCT Filed: Jul. 8, 2015
(86) PCT No.: PCT/JP2015/069701

§ 371 Date: Dec. 29, 2016

(30) Foreign Application Priority Data
Jul. 8, 2014 (JP) 2014-140443

(51) Int. Cl. B02C 7/12; B24D 7/14; A47J 19/04

(52) U.S. Cl. CPC B02C 7/12; A47J 19/04; B24D 7/14

(57) ABSTRACT

A grindstone corresponding to a rotatable grindstone or a stationary grindstone can be incorporated in a grinding device and is used for grinding raw materials. The grindstone includes a main body part and an outer circumferential ring part that can be detached from each other. The main body part has a coarse grinding part in which coarse grinding grooves corresponding to first coarse grinding grooves and second coarse grinding grooves for initially grinding the raw materials are formed. The outer circumferential ring part has a fine grinding part corresponding to a wall part in which fine grinding grooves for further grinding the raw materials ground by the coarse grinding part are formed. When the main body part and the outer circumferential ring part are assembled, the fine grinding part corresponding to the wall part is located at an outer circumference of the coarse grinding part.

### CROSS-REFERENCE TO RELATED APPLICATION

This application is based upon claims the benefit of priority from the priority Japanese Patent Application No. 2014-140443, filed on Jul. 8, 2014, and the entire contents of which are incorporated herein by reference.

### TECHNICAL FIELD

The present invention relates to a grindstone for grinding various materials such as foods, medicaments, chemical feedstocks, and so on, and a grinding device using the same.

### BACKGROUND ART

As a grinding device grinding various materials such as foods, medicaments, chemical feedstocks, and so on, various types are proposed. As to a grindstone used in such a grinding device, more various types than before are proposed.

As a method of manufacturing a grindstone, a method of firing and hardening abrasive grains (a granular material) such as alumina, and a binder has been used. In this method, the binder before the firing is powder, and fills a gap between the abrasive grains. However, there is a problem that, as the binder is melted and vitrified in a high-temperature environment in the firing process and is attached around the abrasive grains, gaps (pores) are generated.

When a material to be ground enters these gaps, it is not easy to remove the material entering the gaps. A food raw material accounts for proliferation of bacteria within the gaps. Moreover, as abrasion of the abrasive grains progresses, a lack or the like of the abrasive grains occurs, which accounts for damage to a pump rotor or a seal slide part, a screen of a separation device, etc. in the following processes.

To solve the above problem, a grindstone in which a resin such as an epoxy resin is molded as a binder and gaps are eliminated is proposed (PTL 1). However, there is a risk of the resin being scraped to be mixed into a material in a process of grinding the material. Especially, there are also many users who worry about safety of bisphenol A becoming a raw material of the epoxy resin.

A grindstone having a two-layered structure in which a grinding portion of a surface abutting to a material is formed of coarse abrasive grains, and a main body portion is formed of fine abrasive grains is also proposed (PTL 2). As the main body portion is formed of fine abrasive grains, gaps can be reduced. However, since a property of absorbing water is not changed even if the gaps are reduced, a problem occurs when a material containing much moisture is ground. Moreover, cleanability is also unsatisfactory.

Since the above type of grindstone uses the abrasive grains, the grindstone may not be recognized as a machine for manufacturing food depending on country or district. For this reason, a grindstone made of a metal such as stainless steel that is a material desirable as a food machine is required.

### CITATION LIST

### Patent Literature

[PTL 1]: JP-B-548-018196

[PTL 2]: JP-B-H07-010497

### SUMMARY OF INVENTION

### Technical Problem

As a grinding device that has a metal portion abutting on a material, a device such as an impact type pulverizer (a crusher, a pin mill, or a hammer mill) is generally known. If a material containing a foamable component such as, for instance, soybeans is ground using this device, there is a problem that a large amount of bubbles occurs easily. Thus, a grinding device of a grinding type rather than a grinding type is preferred for grinding of the material containing the foamable component.

The present invention provides a grindstone that is capable of finely grinding a material (a raw material) and uses a material that is easily handled and is sanitary and safe, and a grinding device using the same.

### Solution to Problem

A grindstone of the present invention is a grindstone that is incorporable in a grinding device and is used for grinding raw materials, and includes a main body part and an outer circumferential ring part that are detachable from each other. The main body part has a coarse grinding part in which coarse grinding grooves for initially grinding the raw materials are formed. The outer circumferential ring part has a fine grinding part in which fine grinding grooves for further grinding the raw materials ground by the coarse grinding part are formed. When the main body part and the outer circumferential ring part are assembled, the fine grinding part is located at an outer circumference of the coarse grinding part.

As an aspect of the grindstone of the present invention, for example, the main body part further includes a medium grinding part which is formed along the outer circumference of the coarse grinding part and in which medium grinding grooves for further grinding the raw materials ground by the coarse grinding part are formed, and when the main body part and the outer circumferential ring part are assembled, the fine grinding part is located at an outer circumference of the medium grinding part.

As an aspect of the grindstone of the present invention, for example, a depth of the fine grinding groove at an inside position of the fine grinding part is equal to or greater than a depth of the medium grinding groove.

As an aspect of the grindstone of the present invention, for example, the fine grinding groove has a sawtooth-shaped cross section.

As an aspect of the grindstone of the present invention, for example, the fine grinding grooves are formed on a normal line extending from a central portion of the outer circumferential ring part to be orthogonal to an outer circumference of the outer circumferential ring part.

As an aspect of the grindstone of the present invention, for example, the fine grinding grooves are formed to secure a predetermined inclined angle with respect to a normal line extending from a central portion of the outer circumferential ring part to be orthogonal to an outer circumference of the outer circumferential ring part.

As an aspect of the grindstone of the present invention, for example, the outer circumferential ring part includes a first outer circumferential ring part that abuts to an outside of the main body part, and a second outer circumferential ring part that is disposed outside the first outer circumferential ring part and has superfine grinding grooves smaller than the fine grinding grooves.

As an aspect of the grindstone of the present invention, for example, the main body part and the outer circumferential ring part have fixing members for preventing idling with other rotating members during rotation.

A grinding device having the grindstone of the present invention is also provided as the present invention.

### Advantageous Effects of Invention

According to the grindstone and the grinding device of the present invention, since a material (a raw material) can be finely ground, and handling such as disassembly and cleaning of the grindstone and the grinding device is easy, efficiency of processes in an industrial field in which it is necessary to grind a raw material is improved.

### BRIEF DESCRIPTION OF DRAWINGS

FIG. 1 is a side view of a grinding device using a grindstone of the present invention.

FIG. 2 is an exploded view illustrating a state in which a stationary grindstone is removed at an upper portion of the grinding device.

FIG. 3 is an exploded view illustrating a state in which an opening/closing lid is opened to remove a rotatable grindstone at the upper portion of the grinding device.

FIGS. 4A through 4E are views illustrating a main body part of the rotatable grindstone, wherein FIG. 4A is a top view of the main body part, FIG. 4B is a cross-sectional view taken along line B-B of FIG. 4A, FIG. 4C is an enlarged view when viewed in a direction of an arrow C of FIG. 4A, FIG. 4D is a cross-sectional view taken along line D-D of FIG. 4A, and FIG. 4E is an enlarged view of a portion E of FIG. 4A.

FIGS. 5A through 5E are views illustrating an outer circumferential ring part of the rotatable grindstone, wherein FIG. 5A is a top view of the outer circumferential ring part, FIG. 5B is a cross-sectional view taken along line B-B of FIG. 5A, FIG. 5C is an enlarged cross-sectional view taken along line C-C of FIG. 5A, FIG. 5D is an enlarged view when viewed in a direction of an arrow D of FIG. 5C, and FIG. 5E is an enlarged view of a portion E of FIG. 5A.

FIGS. 6A and 6B are cross-sectional views of the rotatable grindstone in which the main body part and the outer circumferential ring part are assembled, wherein FIG. 6A is a cross-sectional view of the whole of the rotatable grindstone, and FIG. 6B is an enlarged view of a portion B of FIG. 6A.

FIGS. 7A through 7C are views illustrating modifications of fine grinding grooves of the outer circumferential ring part at the rotatable grindstone, wherein FIGS. 7A and 7B are enlarged views illustrating one modification, and FIG. 7C is an enlarged view further illustrating another modification.

FIGS. 8A through 8E is a view illustrating a main body part of the stationary grindstone, wherein FIG. 8A is a top view of the main body part, FIG. 8B is a cross-sectional view taken along line B-B of FIG. 8A, FIG. 8C is an enlarged view when viewed in a direction of an arrow C of FIG. 8A, FIG. 8D is a cross-sectional view taken along line D-D of FIG. 8A, and FIG. 8E is an enlarged view of a portion E of FIG. 8A.

FIGS. 9A through 9E are views illustrating an outer circumferential ring part of the stationary grindstone, wherein FIG. 9A is a top view of the outer circumferential ring part, FIG. 9B is a cross-sectional view taken along line B-B of FIG. 9A, FIG. 9C is an enlarged cross-sectional view taken along line C-C of FIG. 9A, FIG. 9D is an enlarged view when viewed in a direction of an arrow D of FIG. 9C, and FIG. 9E is an enlarged view of a portion E of FIG. 9A.

FIGS. 10A and 10B are cross-sectional views of the stationary grindstone in which the main body part and the outer circumferential ring part are assembled, wherein FIG. 10A is a cross-sectional view of the whole of the stationary grindstone, and FIG. 10B is an enlarged view of a portion B of FIG. 10A.

FIGS. 11A and 11B are top views of the grindstone completed by assembling the main body parts and the outer circumferential ring parts, wherein FIG. 11A is a top view of the rotatable grindstone, and FIG. 11B is a top view of the stationary grindstone.

FIGS. 12A and 12B are cross-sectional views of the grindstone completed by assembling one main body part and two outer circumferential ring parts, wherein FIG. 12A is a cross-sectional view of the rotatable grindstone, and FIG. 12B is a cross-sectional view of the stationary grindstone.

### DESCRIPTION OF EMBODIMENTS

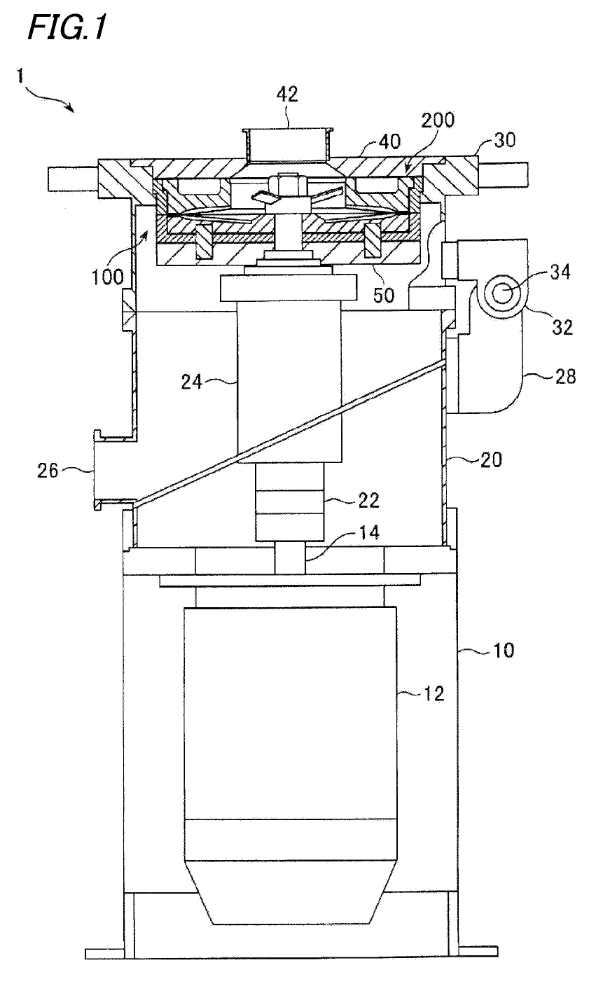

FIG. 1 illustrates an embodiment of a grinding device using a grindstone of the present invention. A grinding device 1 of the present embodiment is a grinding device that is favorably used to grind soybeans absorbing water as a raw material. The grinding device 1 is provided with a lower housing 10 that is installed on a floor or a machine frame, an upper housing 20 that is mounted on an upper portion of the lower housing 10, an opening/closing lid 30 that is openably mounted on an upper portion of the upper housing 20, and a lid 40 that is disposed on an upper surface of the opening/closing lid 30. For description, a state in which the inside of the device is exposed is illustrated in FIGS. 1 to 3.

As a power source, a motor 12 connected to an external power supply (not shown) is housed in the lower housing 10. A coupling 22 that is coupled to a motor rotating shaft 14 of the motor 12 and transmits rotation of the motor 12 and a bearing case 24 into which a bearing holding a rotating shaft 24a coupled to the coupling 22 is incorporated are housed in the upper housing 20. An outlet 26 for discharging a ground raw material to the outside is formed in a lateral surface of the upper housing 20.

The opening/closing lid 30 is provided with a lid side hinge part 32. The lid side hinge part 32 is coupled with a housing side hinge part 28 provided on the lateral surface of the upper housing 20 via a pivotal shaft 34. A support plate 50 splined and fitted to the rotating shaft 24a is provided inside the opening/closing lid 30. A rotatable grindstone 100 (to be described below) is disposed on an upper surface of the support plate 50. Along with rotation of the rotating shaft 24a, the support plate 50 and the rotatable grindstone 100 are rotated.

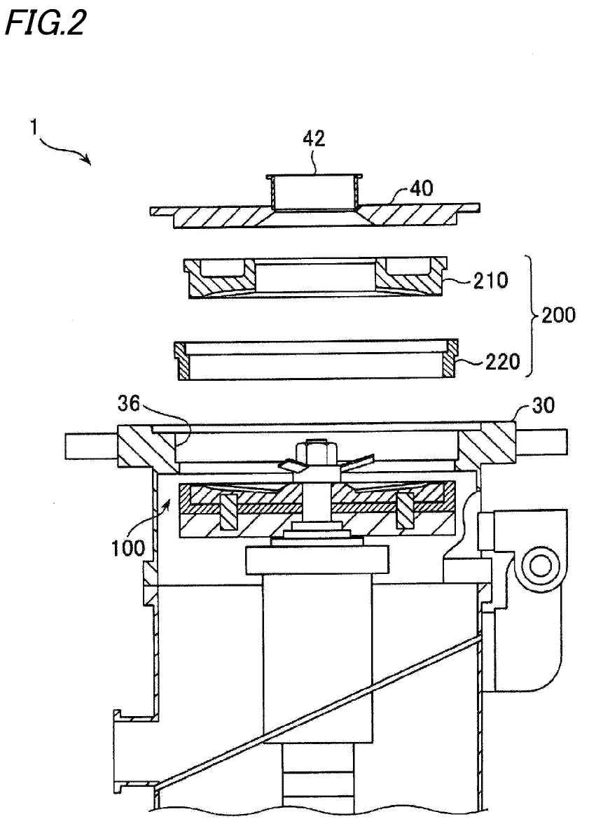

The lid 40 is disposed on the upper surface of the opening/closing lid 30. A recess 36 (see FIG. 2) is formed inside the upper surface of the opening/closing lid 30 in a top view (in a state viewed in an upward direction of FIG. 1). The lid 40 is disposed in the recess 36. A raw material feed port 42 is formed in the lid 40. Soybeans and water, both of which act as raw materials, are fed by another device and a human hand via the raw material feed port 42. A stationary grindstone 200 (to be described below) is also disposed in and fixed to the recess 36.

FIG. 2 is an exploded view illustrating a state in which the stationary grindstone 200 and the lid 40 are removed from the opening/closing lid 30. In this way, an operator can remove the lid 40 from the recess 36 of the upper surface of the opening/closing lid 30 without operating the opening/closing lid 30, and then further remove the stationary grindstone 200. As illustrated, the stationary grindstone 200 includes a main body part 210 and an outer circumferential ring part 220.

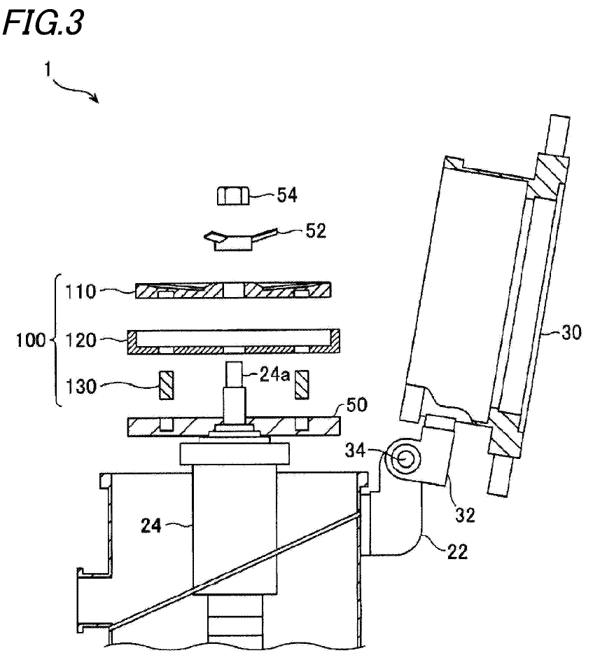

FIG. 3 is an exploded view illustrating a state in which the operator removes the lid 40 and the stationary grindstone 200 from the opening/closing lid 30 as illustrated in FIG. 2, and then opens the opening/closing lid 30 to remove the rotatable grindstone 100. If the operator lifts the opening/closing lid 30 from the state of FIG. 2, the opening/closing lid 30 is pivoted about the pivotal shaft 34, and the rotatable grindstone 100 inside the opening/closing lid 30 is exposed. The rotatable grindstone 100 is disposed on the aforementioned support plate 50, but it is adapted not to run idle relative to the support plate 50 by fixing pins 130. Rotating blades 52 and a nut 54 on the rotatable grindstone 100 are fastened and fixed to the rotating shaft 24a passing through the centers of the support plate 50 and the rotatable grindstone 100, and the rotatable grindstone 100 is strongly fixed to the support plate 50. As the operator removes the rotating blades 52 and the nut 54 from the rotating shaft 24a, the rotatable grindstone 100 can be removed as illustrated in FIG. 3.

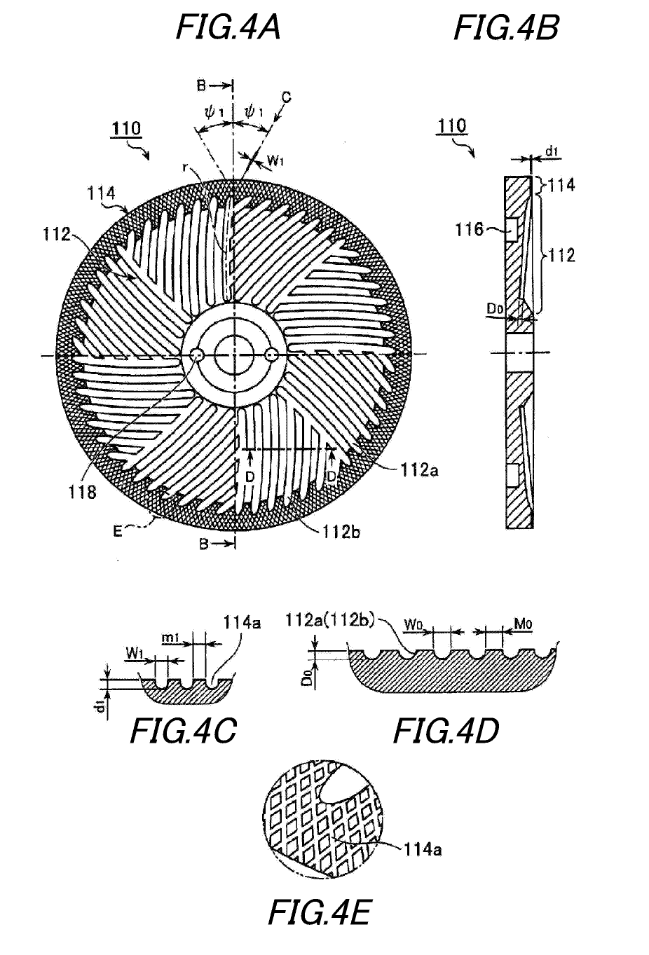

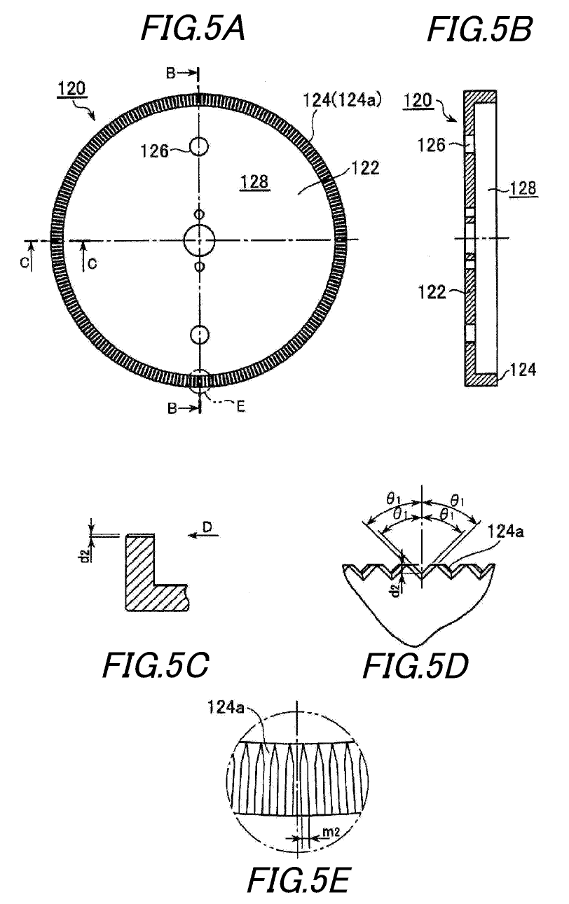

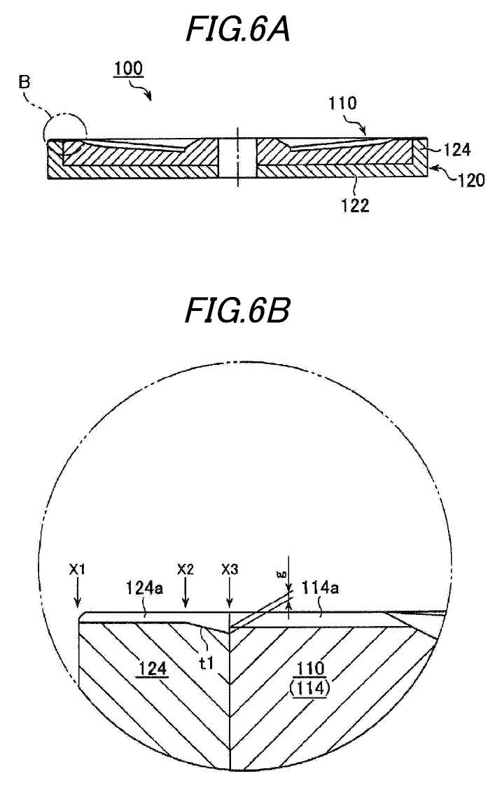

FIGS. 4A to 6B illustrate an example of an embodiment of the rotatable grindstone. The rotatable grindstone 100 includes a main body part 110 and an outer circumferential ring part 120 that are each made of a stainless steel and can be removed from each other. The main body part 110 is fitted into a spatial part 128 (see FIGS. 5A through 5E) of the outer circumferential ring part 120. In the rotatable grindstone 100 (see FIGS. 6A and 6B) in a completed state, the outer circumferential ring part 120 is in a state in which it is present on an outer circumference and one surface of the main body part 110.

The main body part 110 functions as a grindstone portion for coarse and medium grinding, which coarsely grinds a raw material such as soybeans absorbing water and then grinding the raw material to a medium level. On the other hand, the outer circumferential ring part 120 functions as a grindstone portion for final finish, which further grinds the raw material ground to the medium level by the main body part 110, finally performs fine pulverization of the raw material, and grinds the raw material.

In the present embodiment, when a variety of grooves (to be described below) of the main body part 110 and the outer circumferential ring part 120 are formed by cutting or the like, since forms of the grooves of the two parts are entirely different, it is difficult to integrally form the two parts within the single rotatable grindstone. Of course, each of the two parts is considered to be formed by casting or electrical discharge machining. However, a cost may be increased, or an edge quality may not be good. Moreover, as these two parts are integrally formed within the single part, particularly when they are formed of a metal, they become heavy and are difficult to be handled.

In the present embodiment, since the main body part 110 and the outer circumferential ring part 120 can be independently formed by cutting, these two parts can be easily formed. As the main body part 110 and the outer circumferential ring part 120, various types are each prepared, and a combination thereof is changed. Thereby, various types of rotatable grindstones 100 can be provided as finished products. The optimal rotatable grindstone 100 can be prepared according to a kind or a required ground grain size of a raw material, and product quality. Further, when the main body part 110 and the outer circumferential ring part 120 have different levels of wear, only the part having a higher degree of progress of wear can be replaced, and thus an operational cost can be reduced. Moreover, as the grindstone is made of a metal, it is possible to prevent a lack of coarse abrasive grains or mixing of fine abrasive grains or a resin material into a raw material.

The rotatable grindstone 100 of the present embodiment is provided with the two parts, i.e. the main body part 110 and the outer circumferential ring part 120. However, another part is further assembled, and the rotatable grindstone 100 can be made up of three or more parts. In this case, the rotatable grindstone 100 can be made up of three parts, i.e. a coarse grinding part, a medium grinding part, and a fine grinding part.

As will be described below, the coarse grinding part, the medium grinding part, and the fine grinding part are respectively provided with coarse grinding grooves, medium grinding grooves, and fine grinding grooves, and sizes (widths and depths) thereof are generally set within one grindstone in the order of sizes of the coarse grinding grooves, the medium grinding grooves, and the fine grinding grooves. Since the grooves are generally disposed within one grindstone from a central portion, to which a raw material is initially fed, toward an outer circumference in the order of the coarse grinding grooves, the medium grinding grooves, and the fine grinding grooves, the grooves of the outer circumference are smaller than those of the central portion.

Next, the main body part 110 and the outer circumferential ring part 120 of the rotatable grindstone 100 will be individually described. FIGS. 4A through 4E are views illustrating the main body part 110, wherein FIG. 4A is a top view of the main body part 110, FIG. 4B is a cross-sectional view taken along line B-B of FIG. 4A, FIG. 4C is an enlarged view when viewed in a direction of an arrow C of FIG. 4A, FIG. 4D is a cross-sectional view taken along line D-D of FIG. 4A, and FIG. 4E is an enlarged view of a portion E of FIG. 4A.

The main body part 110 includes a coarse grinding part 112 that is formed on a region adjacent to a central portion thereof, and a medium grinding part 114 that is formed outside the coarse grinding part 112 along an outer circumference thereof. The coarse grinding part 112 is a part that initially coarsely grinds a raw material such as soybeans along with the coarse grinding part 212 of the stationary grindstone 200 (to be described below), and is formed such that, in the present embodiment, the coarse grinding grooves are divided into eight parts. The coarse grinding grooves are divided into 3 to 36 parts, and preferably 4 to 12 parts. Hereinafter, in the present embodiment, a description will be made of the division into eight parts. First coarse grinding grooves 112a are grooves that directly extend from the central portion of the main body part 110, and second coarse grinding grooves 112b are grooves that further branch off and extend from the first coarse grinding grooves 112a.

Each of the first and second coarse grinding grooves 112a and 112b has a U-shaped cross section (see FIG. 4D), and its depth (D₀ of FIGS. 4B and 4D) is generally set to be greater than 2 mm and less than or equal to 10 mm. The depth D₀ is preferably set to a range that is greater than 2.5 mm and is less than or equal to 8 mm. Further, a width (W₀ of FIG. 4D) is generally set to a range of 3 mm to 15 mm, and preferably 4 mm to 10 mm.

An interval (M₀ of FIG. 4D) between the neighboring first and second coarse grinding grooves 112a and 112b is generally set to a range that is greater than 1 mm and is less than or equal to 10 mm. The interval M₀ is preferably set to a range that is greater than 2 mm and is less than or equal to 8 mm. Further, a radius r (r of FIG. 4A) of an arc drawn by the first coarse grinding groove 112a is set to be greater than or equal to 50 mm, and preferably greater than or equal to 100 mm.

The medium grinding part 114 is a part that further grinds the raw material coarsely ground by the coarse grinding part 112 to a middle level along with the medium grinding part 214 of the stationary grindstone 200 (to be described below), and is formed with medium grinding grooves 114a (see FIG. 4C). As illustrated in FIG. 4A, the medium grinding grooves 114a are formed by cuts in the outer circumference to secure a predetermined inclined angle ψ₁ with respect to a normal line (a line running along a diameter, for example a line B-B) that extends from the central portion of the main body part 110 to be orthogonal to the outer circumference. The inclined angle ψ₁ is generally set to a range that is greater than or equal to ±10° and is less than or equal to ±60°, and preferably a range that is greater than or equal to ±30° and is less than or equal to±45°. However, a combination of the medium grinding grooves 114a inclined in different directions corresponding to, for instance, +30° and −30° is used. Here, + (plus) is defined as a clockwise angle in a range of 0° to 180° with respect to the normal line (the line B-B), and − (minus) is defined as a counterclockwise angle in a range of 0° to 180° with respect to the normal line (the line B-B). As the medium grinding grooves 114a having the inclined angles ψ₁ of +30° and −30° are combined, the medium grinding grooves 114a are formed to draw a parallelogram (or a rhombus) on a surface of the main body part 110 (see FIG. 4E). In other words, parallelogram (or rhombic) protrusions are provided for the medium grinding part 114.

Each of the medium grinding grooves 114a has a U-shaped cross section (see FIG. 4C), and its depth (d₁ of FIGS. 4B and 4C) is generally set to 0.1 mm to 5 mm. The depth d₁ is preferably set to a range of 0.5 mm to 2 mm. Further, a width (W₁ of FIG. 4C) is generally set to a range of 0.5 mm to 8 mm, and preferably a range of 1 mm to 4 mm.

An interval (m₁ of FIG. 4C) between the neighboring medium grinding grooves 114a is generally set to 0.1 mm to 5 mm. The interval m₁ is preferably set to a range of 0.5 mm to 2 mm.

As the first coarse grinding grooves 112a, the second coarse grinding grooves 112b, and the medium grinding grooves 114a present the U-shaped cross sections, a situation in which it is difficult to get a ground material of the raw material stuck in the grooves occurs rarely, processing capacity is improved, and cleaning also becomes easy.

FIGS. 5A through 5E are views illustrating the outer circumferential ring part 120, wherein FIG. 5A is a top view of the outer circumferential ring part 120, FIG. 5B is a cross-sectional view taken along line B-B of FIG. 5A, FIG. 5C is an enlarged cross-sectional view taken along line C-C of FIG. 5A, FIG. 5D is an enlarged view when viewed in a direction of an arrow D of FIG. 5C, and FIG. 5E is an enlarged view of a portion E of FIG. 5A.

The outer circumferential ring part 120 is a part that more finely grinds the raw material ground to the middle level at the medium grinding part 114 of the main body part 110. The outer circumferential ring part 120 includes a plane part 122 that is of a circular tabular shape, and a wall part 124 that acts as a fine grinding part formed to extend from an outer circumference of the plane part 122 in an approximately vertical direction. A space part 128 into which the main body part is fitted is defined by the plane part 122 and the wall part 124 acting as the fine grinding part.

As illustrated in FIGS. 5A, 5D and 5E, fine grinding grooves 124a are formed on an upper surface of the wall part 124 acting as the fine grinding part. In the present example, each of the fine grinding grooves 124a has a V-shaped cross section (see FIG. 5D), and its depth (d₂ of FIGS. 5C and 5D) is generally set to be greater than 0.3 mm and less than or equal to 2 mm. The depth d₂ is preferably set to be greater than 0.5 mm and less than or equal to 1 mm. In the present example, the fine grinding grooves 124a are formed by cuts on the upper surface of the wall part 124 acting as the fine grinding part on a normal line (a line running along a diameter, for example a line B-B) extending from the central portion of the main body part 110 or the outer circumferential ring part 120 to be orthogonal to the outer circumference.

An interval (m₂ of FIG. 5E) between the two neighboring fine grinding grooves 124a is generally set to be greater than 0.3 mm and less than or equal to 2 mm. The interval m₂ is preferably set to a range that is greater than 0.5 mm and is less than or equal to 1 mm. A spread angle (a cross-sectional angle) θ₁ (see FIG. 5D) in a cross section showing a V-shaped spread is generally set to 5° to 70°. The spread angle θ₁ is preferably set to a range of 30° to 45°.

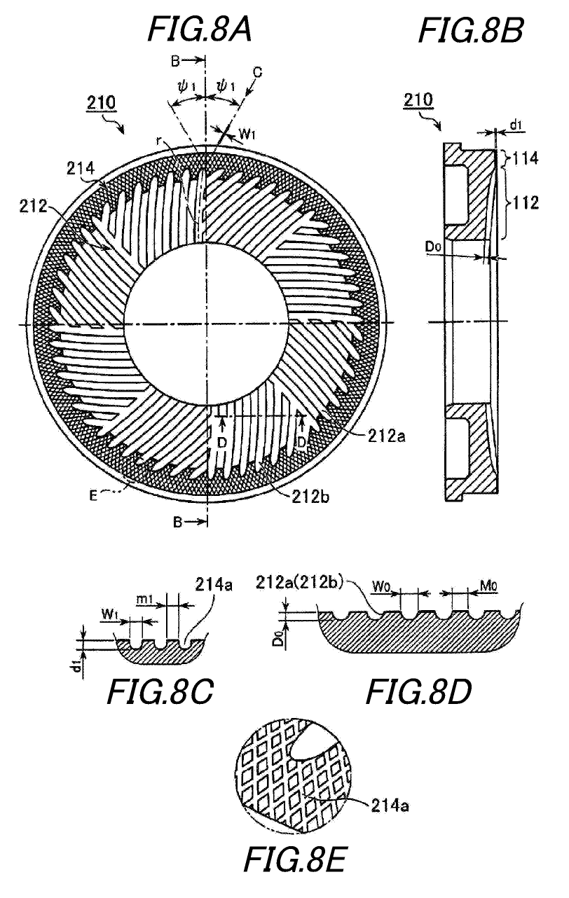

The number of medium grinding grooves 114a and the number of fine grinding grooves 124a in FIGS. 4A and 5A are not necessarily accurate at actual products. The number of these grooves in the actual products is still more. In the present specification, the number of grooves is reduced with the emphasis of an easy view. This is the same as in FIGS. 8A, 9A, 11A and 11B to be described below.

FIGS. 6A and 6B are cross-sectional views of the rotatable grindstone 100 in which the main body part 110 and the outer circumferential ring part 120 are assembled, wherein FIG. 6A is a cross-sectional view of the whole of the rotatable grindstone 100, and FIG. 6B is an enlarged view of a portion B of FIG. 6A. A worker fits the main body part 110 into the space part 128 of the outer circumferential ring part 120 (see FIGS. 5A through 5E), and thereby the rotatable grindstone 100 is completed.

As illustrated in FIG. 6A, a surface opposite to the surface of the main body part 110 in which the grooves are formed and the plane part 122 of the outer circumferential ring part 120 abut to each other, and the wall part 124 acting as the fine grinding part of the outer circumferential ring part 120 abuts to the outer circumference of the main body part 110. When the main body part 110 and the outer circumferential ring part 120 are assembled, the wall part 124 acting as the fine grinding part is located at an outer circumference of the medium grinding part 114 of the main body part 110. If only the coarse grinding part 112 but not the medium grinding part 114 is provided for the main body part 110, when the main body part 110 and the outer circumferential ring part 120 are assembled, the wall part 124 acting as the fine grinding part is located at an outer circumference of the coarse grinding part 112.

As illustrated in FIG. 6B, there is a step g between the bottom of the medium grinding groove 114a at the medium grinding part 114 of the main body part 110 and the bottom of the fine grinding groove 124a of the upper surface of the wall part 124 acting as the fine grinding part. A size of the step g is generally set to a range of 0 mm to 2 mm, and preferably a range of 0 mm to 1 mm. In the embodiment, the depth d₂ of the fine grinding groove 124a is different at an outermost circumferential position X1 of the wall part 124 acting as the fine grinding part of the outer circumferential ring part 120 and at an inside position X3 of the wall part 124 (see FIG. 6B). That is, as illustrated in FIG. 6B, the bottom of the fine grinding groove 124a becomes a tapered surface t1 from an intermediate position X2 of the wall part 124 acting as the fine grinding part to the inside position X3. The fine grinding groove 124a is deeply cut from the intermediate position X2 to the inside position X3 in a tapered shape at a portion of the tapered surface t1.

Therefore, as to a relationship between the depth d₁ of the medium grinding groove 114a and the depth d₂ of the fine grinding groove 124a, even if the relationship is depth d₁>depth d₂ at the outermost circumferential position X1, the relationship is set to depth d₁≦depth d₂ at the inside position X3. In the case of d₁=d₂, there is no step g. That is, the depth d₂ of the fine grinding groove 124a at the inside position X3 of the wall part 124 acting as the fine grinding part is set to be equal to or greater than the depth d₁ of the medium grinding groove 114a. In this case, the raw material does not collide with and stay at the wall of the outer circumferential ring part 120 at the outermost circumference of the main body part 110, but it is smoothly fed from the main body part 110 to the outer circumferential ring part 120.

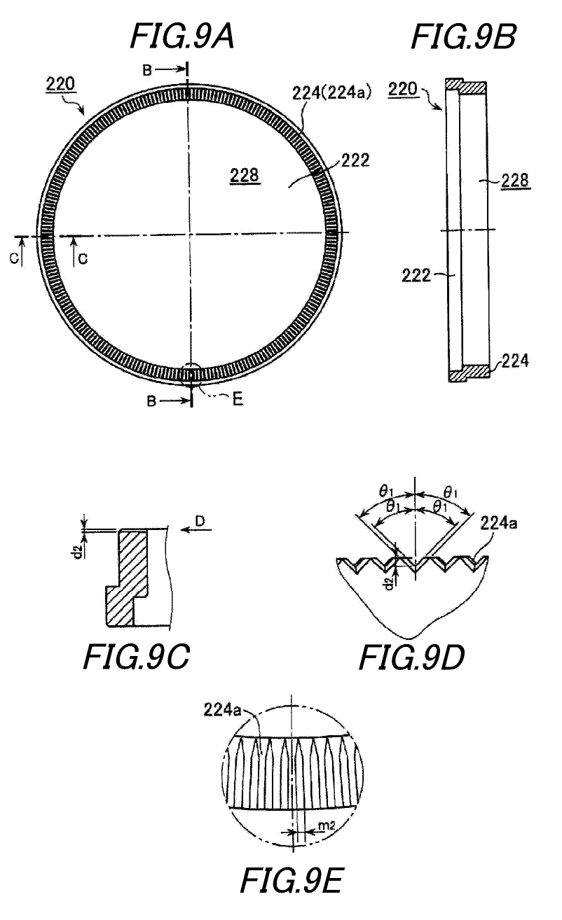

The plane part 122 of the outer circumferential ring part 120 is not essential, but it may be omitted like the outer circumferential ring part 220 of the stationary grindstone 200 to be described below (see FIGS. 9A through 9E).

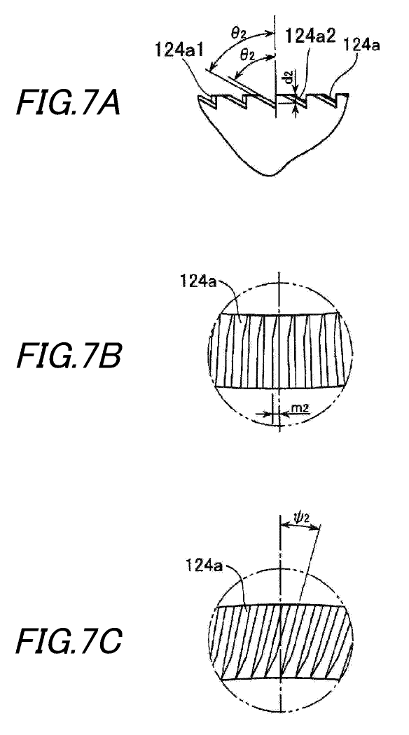

FIGS. 7A through 7C illustrate modifications of the fine grinding grooves 124a of the outer circumferential ring part 120. In the modifications of FIGS. 7A and 7B, the fine grinding grooves 124a have sawtooth-shaped cross sections, or present oblique V-shaped cross sections. In the fine grinding grooves 124a, one wall 124a1 of the groove is formed to be perpendicular to the upper surface of the wall part 124 of the outer circumferential ring part 120, and the other wall 124a2 is formed to be inclined with respect to the upper surface of the wall part 124 in the same way as the V shape of FIG. 5D. Moreover, a spread angle (a cross-sectional angle) θ₂ (see FIG. 7A) in a cross section showing a sawtooth-shaped spread is generally set to 5° to 80°. The spread angle θ₂ is preferably set to 45° to 60°. The other values are the same as those illustrated in FIGS. 5A through 5E.

In the modification of the fine grinding grooves 124a illustrated in FIG. 7C, the fine grinding grooves 124a are formed by cuts in the upper surface of the wall part 124 acting as the fine grinding part to secure a predetermined inclined angle ψ₂ with respect to the normal line (the line running along the diameter, for example the line B-B of FIG. 5A) that extends from the central portion of the main body part 110 or the outer circumferential ring part 120 to be orthogonal to the outer circumference. The inclined angle ψ₂ is generally set to a range of 0° to 45°, and preferably a range of 0° to 15° (ψ₂=0° in the examples of FIGS. 5E and 7B). The other values are the same as those illustrated in FIGS. 5A through 5E.

Next, the main body part 210 and the outer circumferential ring part 220 of the stationary grindstone 200 will be individually described. FIGS. 8A through 8E are views illustrating the main body part 210 of the stationary grindstone 200, wherein FIG. 8A is a top view of the main body part 210, FIG. 8B is a cross-sectional view taken along line B-B of FIG. 8A, FIG. 8C is an enlarged view when viewed in a direction of an arrow C of FIG. 8A, FIG. 8D is a cross-sectional view taken along line D-D of FIG. 8A, and FIG. 8E is an enlarged view of a portion E of FIG. 8A.

The main body part 210 includes a coarse grinding part 212 formed on a region adjacent to a central portion thereof, and a medium grinding part 214 that is formed outside the coarse grinding part 212 along an outer circumference thereof. The coarse grinding part 212 is a part that initially coarsely grinds a raw material such as soybeans along with the coarse grinding part 112 of the aforementioned rotatable grindstone 100, and is formed with coarse grinding grooves. First coarse grinding grooves 212a are grooves that directly extend from the central portion of the main body part 210, and second coarse grinding grooves 212b are grooves that further branch off and extend from the first coarse grinding grooves 212a.

Each of the first and second coarse grinding grooves 212a and 212b has a cross-sectional shape, a depth D₀, a width W₀, an interval M₀ between the neighboring grooves, and a radius r of an arc drawn by each of the first coarse grinding grooves 212a, all of which can be set to the same ranges as in each of the first and second coarse grinding grooves 112a and 112b of the rotatable grindstone 100.

The medium grinding part 214 is a part that further grinds the raw material coarsely ground by the coarse grinding part 212 to a middle level along with the medium grinding part 114 of the aforementioned rotatable grindstone 100, and is formed with medium grinding grooves 214a. The medium grinding grooves 214a are formed by cuts in the outer circumference to secure a predetermined inclined angle ψ₁ with respect to a normal line (a line running along a diameter, for example a line B-B) that extends from the central portion of the main body part 210 to be orthogonal to the outer circumference.

Each of the medium grinding grooves 214a has a cross-sectional shape, an inclined angle ψ₁, a depth d₁, a width W₁, and an interval m₁ between the grooves, all of which can be set to the same ranges as in each of the medium grinding grooves 114a of the medium grinding part 114 of the rotatable grindstone 100. As the medium grinding grooves 214a having the inclined angles ψ₁ of +30° and −30° are combined, the medium grinding grooves 214a are formed to draw a parallelogram (or a rhombus) on a surface of the main body part 210 (see FIG. 8E). In other words, parallelogram (or rhombic) protrusions are provided for the medium grinding part 214. Like the rotatable grindstone 100, as the first coarse grinding grooves 212a, the second coarse grinding grooves 212b, and the medium grinding grooves 214a also present the U-shaped cross sections in the stationary grindstone 200, a situation in which it is difficult to get a ground material of the raw material stuck in the grooves occurs rarely, and handling becomes easy.

FIGS. 9A through 9E are views illustrating the outer circumferential ring part 220 of the stationary grindstone 200, wherein FIG. 9A is a top view of the outer circumferential ring part 220, FIG. 9B is a cross-sectional view taken along line B-B of FIG. 9A, FIG. 9C is an enlarged cross-sectional view taken along line C-C of FIG. 9A, FIG. 9D is an enlarged view when viewed in a direction of an arrow D of FIG. 9C, and FIG. 9E is an enlarged view of a portion E of FIG. 9A.

The outer circumferential ring part 220 is a part that more finely grinds the raw material ground to the middle level at the medium grinding part 214 of the main body part 210. Unlike the outer circumferential ring part 120, the outer circumferential ring part 220 is substantially made up of only a wall part 224 that acts as a fine grinding part without a plane part. A space part 228 into which the main body part is fitted is defined inside the wall part 224 acting as the fine grinding part.

As illustrated in FIGS. 9A, 9D and 9E, fine grinding grooves 224a are formed on an upper surface of the wall part 224 acting as the fine grinding part. Each of the fine grinding grooves 224a has a cross section, a depth d₂, an interval m₂ between the neighboring grooves, and a cross-sectional angle θ₁, all of which can be set to the same ranges as in each of the fine grinding grooves 124a of the outer circumferential ring part 120 of the rotatable grindstone 100.

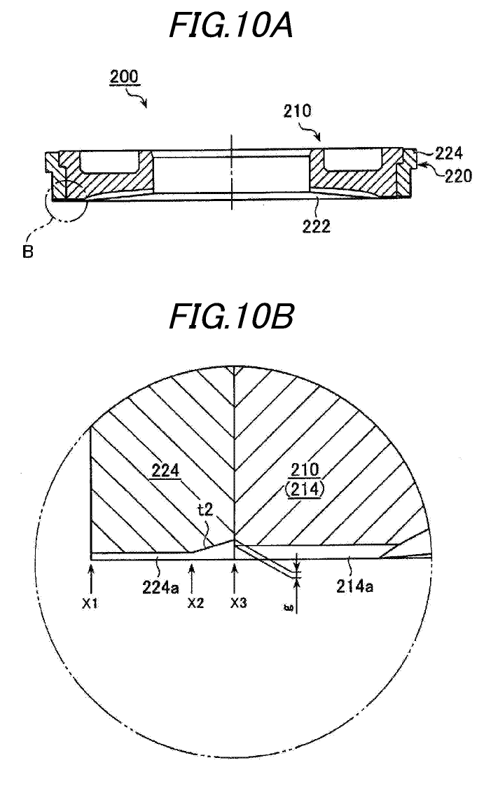

FIGS. 10A and 10B are cross-sectional views of the stationary grindstone 200 in which the main body part 210 and the outer circumferential ring part 220 are assembled, wherein FIG. 10A is a cross-sectional view of the whole of the stationary grindstone 200, and FIG. 10B is an enlarged view of a portion B of FIG. 10A. A worker fits the main body part 210 into the space part 228 of the outer circumferential ring part 220 (see FIGS. 9A through 9E), and thereby the stationary grindstone 200 is completed.

As illustrated in FIG. 10A, when the main body part 210 and the outer circumferential ring part 220 are assembled, the wall part 224 acting as the fine grinding part is located at an outer circumference of the medium grinding part 214 of the main body part 210. If only the coarse grinding part 212 but not the medium grinding part 214 is provided for the main body part 210, when the main body part 210 and the outer circumferential ring part 220 are assembled, the wall part 224 acting as the fine grinding part is located at an outer circumference of the coarse grinding part 212.

As illustrated in FIG. 10B, there is a step g between the bottom of the medium grinding groove 214a at the medium grinding part 214 of the main body part 210 and the bottom of the fine grinding groove 224a of the upper surface of the wall part 224 acting as the fine grinding part. A size of the step g can be set to the same range as in the step g (see FIG. 6B) in the rotatable grindstone 100. In the present embodiment, the depth d₂ of the fine grinding groove 224a is different at an outermost circumferential position X1 of the wall part 224 acting as the fine grinding part of the outer circumferential ring part 220 and at an inside position X3 of the wall part 224 (see FIG. 10B). That is, as illustrated in FIG. 10B, the bottom of the fine grinding groove 224a becomes a tapered surface t2 from an intermediate position X2 of the wall part 224 acting as the fine grinding part to the inside position X3. The fine grinding groove 224a is deeply cut from the intermediate position X2 to the inside position X3 in a tapered shape at a portion of the tapered surface t2.

Therefore, as to a relationship between the depth d₁ of the medium grinding groove 214a and the depth d₂ of the fine grinding groove 224a, even if the relationship is depth d₁>depth d₂ at the outermost circumferential position X1, the relationship is set to depth d₁depth d₂ at the inside position X3. In the case of d₁=d₂, there is no step g.

That is, the depth d₂ of the fine grinding groove 224a at the inside position X3 of the wall part 224 acting as the fine grinding part is set to be equal to or greater than the depth d₁ of the medium grinding groove 214a. In this case, the raw material does not collide with and stay at the wall of the outer circumferential ring part 220 at the outermost circumference of the main body part 210, but it is smoothly fed from the main body part 210 to the outer circumferential ring part 220.

When the rotatable grindstone 100 and the stationary grindstone 200 are disposed one above the other, the tapered surface t1 of FIG. 6B and the tapered surface t2 of FIG. 10B face each other. An interval between the bottoms of the tapered surfaces is secured to be wider than that between the bottoms of the medium grinding grooves 114a and 214a at the medium grinding parts 114 and 214. Therefore, the raw material sent from the medium grinding parts 114 and 214 is smoothly fed to the outer circumference side without being blocked.

The same modification as the fine grinding grooves 124a illustrated in FIGS. 7A through 7C may also be adopted for the fine grinding grooves 224a of the outer circumferential ring part 220 in the stationary grindstone 200. Particularly, if the sawtooth-shaped cross sections of the fine grinding grooves 124a of the outer circumferential ring part 120 of FIG. 7A are also adopted to the fine grinding grooves 224a of the outer circumferential ring part 220, when the rotatable grindstone 100 and the stationary grindstone 200 are disposed one above the other, the two sawtooth-shaped fine grinding grooves 124a and 224a face each other. When the grindstones are rotated such that, after oblique parts of the respective grooves face each other, vertical parts face each other, and a strong shear force against the raw material is obtained. However, as to the cross-sectional shapes of the fine grinding grooves 124a of the outer circumferential ring part 120 and the fine grinding grooves 224a of the outer circumferential ring part 220, other shapes such as a U shape, a concave shape, and an inverted trapezoidal shape in addition to the V shape and the sawtooth shape are not denied.

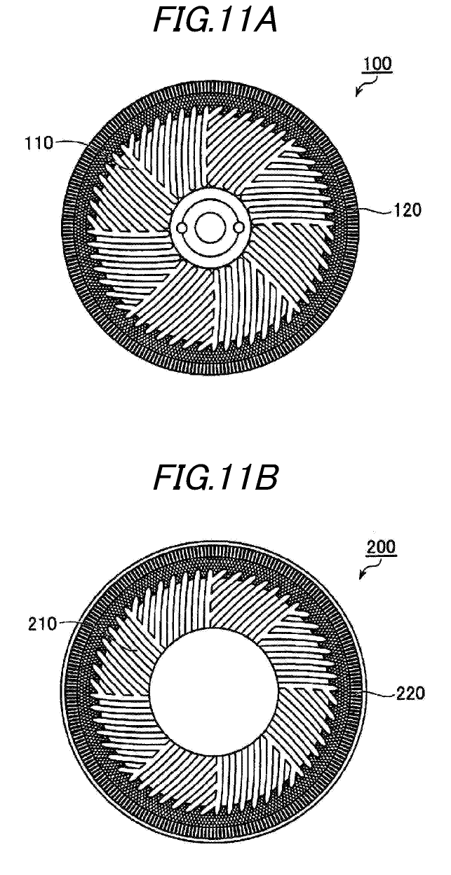

FIGS. 11A and 11B are top views of the grindstone completed by assembling the main body parts 110 and 210 and the outer circumferential ring parts 120 and 220, wherein FIG. 11A is a top view of the rotatable grindstone 100, and FIG. 11B is a top view of the stationary grindstone 200. The top views of FIGS. 11A and 11B are equivalent to the top views of FIGS. 6A, 6B, 10A and 10B.

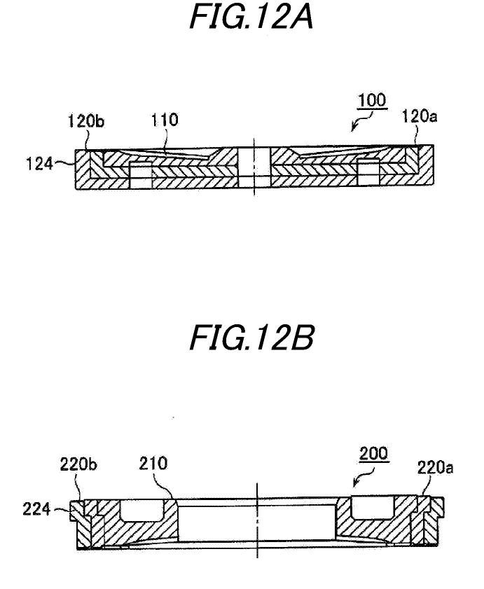

FIGS. 12A and 12B are cross-sectional views of the grindstone completed by assembling the main body parts 110 and 210 and the two outer circumferential ring parts, wherein FIG. 12A is a cross-sectional view of the rotatable grindstone 100, and FIG. 12B is a cross-sectional view of the stationary grindstone 200. That is, as described above, the number of outer circumferential ring parts assembled to the main body part is not limited. Particularly, in the present example, the outer circumferential ring part 120 in the rotatable grindstone 100 includes a first outer circumferential ring part 120a that abuts to the outside of the main body part 110, and a second outer circumferential ring part 120b that is disposed outside the first outer circumferential ring part 120a and has superfine grinding grooves smaller than fine grinding grooves 124a. The outer circumferential ring part 220 in the stationary grindstone 200 includes a first outer circumferential ring part 220a that abuts to the outside of the main body part 210, and a second outer circumferential ring part 220b that is disposed outside the first outer circumferential ring part 220a and has superfine grinding grooves smaller than fine grinding grooves 224a.

The first outer circumferential ring parts 120a and 220a abut to the outsides of the main body parts 110 and 210, and the insides of the second outer circumferential ring parts 120b and 220b. Like the precedent example, the first outer circumferential ring parts 120a and 220a are provided with the fine grinding grooves 124a and 224a. Wall parts 124 and 224 of the second outer circumferential ring parts 120b and 220b are provided with the superfine grinding grooves that are still smaller than (or have smaller widths and depths than) the fine grinding grooves 124a and 224a. To prevent the raw material from being blocked between the first outer circumferential ring parts 120a and 220a and the second outer circumferential ring parts 120b and 220b, tapered surfaces t1 and t2 as illustrated in FIGS. 6B and 10B can be provided for the superfine grinding grooves of the second outer circumferential ring parts 120b and 220b.

The rotatable grindstone 100 and the stationary grindstone 200 include a common design idea. With regard to the common design idea, both of them can be grasped as a “grindstone.” Various embodiments of the rotatable grindstone 100 and various embodiments of the stationary grindstone 200 can be arbitrarily combined.

A gap (a clearance) between the rotatable grindstone 100 and the stationary grindstone 200, namely, a gap between the outer circumferential ring parts 120 and 220 is generally set to a range of 0.01 mm to 1 mm, and preferably a range of 0.1 mm to 0.5 mm. Each of the rotatable grindstone 100 and the stationary grindstone 200 is angled from a central portion thereof to an outer circumferential portion thereof in a tapered shape. A clearance (an allowance) or a tapered angle of a material input port is appropriately selected according to a size of the material.

When only the central portion of the rotatable grindstone 100 is fastened to the rotating shaft 24a using the rotating blades 52 and the nut 54 (see FIG. 3), if a predetermined force is applied to the outer circumference of the rotatable grindstone 100 during grinding, there is a possibility of idling (slip) occurring between the rotatable grindstone 100 and the rotating shaft 24a. Therefore, in the present embodiment, the rotatable grindstone 100 is fixed to the support plate 50 using the removable fixing pins 130. Through-holes 126 through which the fixing pins 130 pass are formed in the plane part 122 of the outer circumferential ring part 120 (see FIGS. 5A and 5B). Recesses 116 in which tips of the fixing pins 130 passing through the through-holes 126 are housed are formed in the main body part 110 (see FIG. 4B). However, adoption of the fixing pins 130 is not essential, and the through-holes 126 and the recesses 116 are also not essential.

In the above example, the main body part 110 has the recesses 116, and the outer circumferential ring part 120 has the through-holes 126. The recesses 116 and the through-holes 126 play a role as fixing members for preventing idling with other rotating members such as the rotating shaft 24a and the support plate 50 during rotation in combination with the removable fixing pins 130. However, the idling may be prevented by providing protruding members such as pins acting as the fixing members for the main body part 110 and the outer circumferential ring part 120, and fitting the protruding members into the recesses or the like provided in the support plate 50.

The stationary grindstone 200 is fixed to the upper surface of the opening/closing lid 30 via the lid 40 at the outer circumference thereof (see FIG. 2), and has a low need to adopt the fixing pins, compared to the rotatable grindstone 100. However, the stationary grindstone 200 may also be fixed using the fixing pins.

If a grindstone (a vitrified grindstone, a ceramic grindstone, or the like) manufactured by firing is strongly fastened to another member, there is a risk of cracks occurring. Since the rotatable grindstone 100 and the stationary grindstone 200 of the present embodiment are made of stainless steel (SUS), they can be strongly fastened to the other members when fixed.

Further, the rotatable grindstone 100 of the present embodiment is provided with female holes 118 for removal (see FIG. 4A). In a state in which a liquid is infiltrated into and closely attached to the gap between the main body part 110 and the outer circumferential ring part 120 as in FIGS. 6A and 6B, it is not easy to remove the main body part 110 from the outer circumferential ring part 120 in some cases. Therefore, a worker screws male screws (not shown) for removal into the female holes 118, and separates the main body part 110 from the outer circumferential ring part 120. Thereby, the worker can easily remove the main body part 110 from the outer circumferential ring part 120. As disassembly and assembly become easy, a frequency of cleaning can be increased, and the device can be sanitarily maintained.

The gap between the main body part 110 (210) and the outer circumferential ring part 120 (220) can also be sealed with a seal member such as an O-ring. Of course, emphasis is put on easiness of disassembly and cleaning, and there is no need to necessarily provide the seal member.

A surface hardening treatment (surface modification, coating, or the like) can also be performed on both or any one of the main body part 110 (210) and the outer circumferential ring part 120 (220) to improve wear resistance. Surface modification of the material includes, for instance, a shot peening treatment or a nitriding treatment. In addition, the coating includes titanium nitride coating, titanium carbonitride coating, diamond-like carbon (DLC) coating, chromium nitride coating, titanium aluminum nitride coating, chromium carbide coating, ceramic spraying, or a laminated film obtained by combining these.

The motor 12 of the grinding device 1 of the embodiment may be changed in the number of motor poles and be driven under inverter control according to service conditions. Since the grindstone is made of stainless steel, stains are easily eliminated. Moreover, since the grindstone is resistant to chemicals or heat, circulation cleaning or cleaning in place (CIP) using a chemical solution is possible. The grinding device 1 can also be used as an in-line grinder, and disassembly cleaning is also easy after the circulation cleaning.

The rotating shaft of the motor 12 may be disposed in an arbitrary style such as a vertical style, a transverse style, an oblique style, or the like.

In the grinding device 1 of the present embodiment, since there is no water infiltrated into the rotatable grindstone 100 and the stationary grindstone 200, the balance of dipped soybeans and water is hardly destroyed, a fluid level is maintained at a position that is still higher than the raw material feed port 42, and a discharge pump is provided behind the outlet 26. Thereby, the grinding device 1 can be suitably used as a submerged grinding device.

In a typical process of producing a bean curd, first, soybeans are immersed in water overnight and are caused to absorb water. The soybeans absorbing water (called immersed soybeans or dipped soybeans) have weight from 2.2 times to 2.3 times original soybeans. As the soybeans absorbing water (the immersed soybeans) are fed to the grinding device 1 along with water, the soybeans are ground.

The immersed soybeans are weighed by a weighing instrument, and then are fed to the grinding device 1. A type of the weighing instrument includes a cubic-measure type weighing instrument in which a cut amount is changed in proportion to the number of rotations, a screw conveyor mode in which an amount of feed is adjusted by changing the number of rotations of a screw, a vibrating feeder in which an amount of feed is adjusted by adjusting a frequency of a trough, and so on. A method of feeding water includes a method of adjusting a valve opening degree with a hand while checking a flow rate with a flowmeter, a method of adjusting the number of rotations of a displacement pump, or a method of automatically controlling these under feedback control.

The grinding device 1 is provided with a hopper (not shown) at an upper portion of the raw material feed port 42 of the lid 40. The immersed soybeans fed from the hopper along with water are guided to the gap between the stationary grindstone 200 and the rotatable grindstone 100 by the rotating blades 52 mounted on the rotating shaft 24a.

The fed immersed soybeans are crushed between the coarse grinding grooves (the first and second coarse grinding grooves) 112a and 112b of the rotatable grindstone 100 and the coarse grinding grooves (the first and second coarse grinding grooves) 212a and 212b of the stationary grindstone 200. Further, the soybeans are sent in an outer circumferential direction by a centrifugal force generated by rotation of the rotatable grindstone 100 and actions of the coarse grinding grooves (the first and second coarse grinding grooves) 112a and 112b and the coarse grinding grooves (the first and second coarse grinding grooves) 212a and 212b, both of which have sweepback angles with respect to a radial direction of the grindstone.

Since the coarse grinding parts 112 and 212 of the rotatable grindstone 100 and the stationary grindstone 200 are tapered such that the gap therebetween is gradually narrowed in the outer circumferential direction, the soybeans are gradually finely crushed.

The soybeans crushed by the coarse grinding parts 112 and 212 go out of the coarse grinding grooves (the first and second coarse grinding grooves) 112a and 112b, the coarse grinding grooves (the first and second coarse grinding grooves) 212a and 212b, and simultaneously are sent to the medium grinding parts 114 and 214. The grinding surfaces of the medium grinding parts 114 and 214 of the rotatable grindstone 100 and the stationary grindstone 200 face each other to be parallel to each other, and are provided on the surface thereof with the infinite rhombic (parallelogram) protrusions (see FIG. 4E). Therefore, the soybeans are further finely ground while being rubbed between the lower rotatable grindstone 100 and the upper stationary grindstone 200 so as to be ground by stone mortars when passing therebetween.

The soybeans finely ground by the medium grinding parts 114 and 214 are sent to the outer circumferential ring parts 120 and 220, and undergo finishing fine grinding. The interval between the two grindstones is smallest at the outer circumferential ring parts 120 and 220, and a circumferential speed is fastest at the outer circumferential ring parts 120 and 220. For this reason, the soybeans receive a strong shear force, and undergo finishing grinding.

Since a conventional grindstone is manufactured by firing a predetermined material, an accurate finished surface is not easily obtained. For this reason, the grain size distribution of the ground raw material tends to be wide. On the other hand, since the grindstone of the present invention is manufactured by machining, an accurate finished surface is easily obtained, and the grain size distribution becomes narrow compared to the conventional grindstone, and an aimed grain size is easily obtained.

The interval between the rotatable grindstone 100 and the stationary grindstone 200 can be adjusted by a clearance adjusting mechanism provided for the grinding device 1, and the ground grain size is changed depending on a degree of adjustment. However, in the grindstone of the present invention, since the outer circumferential ring part can be easily replaced, a combination of the depths of the grooves can be changed depending on the purpose, and the ground material of the raw material having a narrow grain size distribution centered on the aimed grain size can be obtained.

The ground material of the raw material obtained by the grinding device 1 is called a ground soybean slurry (raw ground macerated soybeans), is discharged from the outlet 26, and is sent to the next heating process. The heating process is intended to protein extraction, thermal denaturation of protein, and disinfection. The heated ground soybean slurry is sent to a separation process, and is separated into soymilk and a soy pulp. This soymilk is used to produce bean curds.

The rotatable grindstone, the stationary grindstone, and the grinding device of the present invention can be used for crushing, grinding, and grinding: seeds of crops such as wheat, rice, buckwheat, or corn in addition to the soybeans, and seeds of trees; raw materials for oil expression; raw materials for fruit juice such as green and root vegetables or fruits; dry matters of medical herbs; dry matters of agriculture, forestry, livestock, and fishery products, or the like; or materials or processed goods of these products in a water absorbing state or in a raw state regardless of a dry or wet type. For the purpose of emulsification, dispersion, agitation, etc. in addition to the crushing, the grinding, and the grinding, the present invention can also be applied to the field of a food industry or a chemical industry. Particularly, the present invention is suitably used to grind materials (raw materials), such as soybean, containing a foamable component, raw materials affected by oxygen in air, or raw materials affected by heat generation. The present invention is not particularly limited to grinding the above material while adding water (grinding water) or a liquid material such as liquid fat to the above material.

The present invention is not limited to the aforementioned embodiment, but adequate modification, improvement, etc. are possible. In addition, materials, shapes, dimensions, numerical values, forms, numerals, disposed places, etc. of each component in the aforementioned embodiments are arbitrary as long as the object of the present invention can be achieved, and the present invention is not limited thereto.

This application is based on Japanese Patent Application No. 2014-140443, filed on Jul. 8, 2014, the content of which is incorporated herein by reference.

### INDUSTRIAL APPLICABILITY

According to the grindstone and the grinding device of the present invention, materials (raw materials) can be finely ground to a cell level thereof, a rate of extraction of a solid content is increased. Since the grindstone and the grinding device are easily handled, facilitate cleaning and disinfection or disassembly cleaning, and use a sanitary and safe material, process efficiency in industrial fields required to grind raw materials is improved for either dry grinding or wet grinding.

### REFERENCE SIGNS LIST

1 Grinding device

100 Rotatable grindstone (Grindstone)

110 Main body part

112 Coarse grinding part

112a First coarse grinding groove

112b Second coarse grinding groove

114 Medium grinding part

114a Medium grinding groove

116 Recess

118 Female hole for removal

120 Outer circumferential ring part

122 Plane part

124 Wall part (Fine grinding part)

124a Fine grinding groove

126 Through-hole

128 Space part

200 Stationary grindstone (Grindstone)

210 Main body part

212 Coarse grinding part

212a First coarse grinding groove

212b Second coarse grinding groove

214 Medium grinding part

214a Medium grinding groove

220 Outer circumferential ring part

224 Wall part (Fine grinding part)

224a Fine grinding groove

228 Space part

1. A grindstone which is incorporable in a grinding device and which is used for grinding raw materials, the grindstone comprising:
a main body part and an outer circumferential ring part that are detachable from each other,
wherein the main body part has a coarse grinding part in which coarse grinding grooves for initially grinding the raw materials are formed,
the outer circumferential ring part has a fine grinding part in which fine grinding grooves for further grinding the raw materials ground by the coarse grinding part are formed, and
when the main body part and the outer circumferential ring part are assembled, the fine grinding part is located at an outer circumference of the coarse grinding part.

2. The grindstone according to claim 1,
wherein the main body part further includes a medium grinding part which is formed along the outer circumference of the coarse grinding part and in which medium grinding grooves for further grinding the raw materials ground by the coarse grinding part are formed, and
when the main body part and the outer circumferential ring part are assembled, the fine grinding part is located at an outer circumference of the medium grinding part.

3. The grindstone according to claim 2,
wherein a depth of the fine grinding groove at an inside position of the fine grinding part is equal to or greater than a depth of the medium grinding groove.

4. The grindstone according to claim 1,
wherein the fine grinding groove has a sawtooth-shaped cross section.

5. The grindstone according to claim 1,
wherein the fine grinding grooves are formed on a normal line which extends from a central portion of the outer circumferential ring part and which is orthogonal to an outer circumference of the outer circumferential ring part.

6. The grindstone according to claim 1,
wherein the fine grinding grooves are formed to secure a predetermined inclined angle with respect to a normal line which extends from a central portion of the outer circumferential ring part and which is orthogonal to an outer circumference of the outer circumferential ring part.

7. The grindstone according to claim 1,
wherein the outer circumferential ring part includes:
a first outer circumferential ring part that abuts to an outside of the main body part; and
a second outer circumferential ring part that is arranged outside the first outer circumferential ring part and that has superfine grinding grooves smaller than the fine grinding grooves.

8. The grindstone according to claim 1,
wherein the main body part and the outer circumferential ring part have fixing members to prevent idling with other rotating members during rotation.

9. A grinding device including the grindstone according to claim 1.
